(19) United States
(12) Patent Application Publication
(10) Pub. No.: US 2023/0387817 A1
(43) Pub. Date: Nov. 30, 2023

(54) ADAPTIVE ON-TIME FOR VOLTAGE CONVERTER

(71) Applicant: TEXAS INSTRUMENTS INCORPORATED, Dallas, TX (US)

(72) Inventors: Sombuddha CHAKRABORTY, Redwood City, CA (US); Taisuke KAZAMA, Plano, TX (US); Nicola BERTONI, Freising (DE); Dongbin HOU, Plano, TX (US); Raul BLECIC, Freising (DE); Stefan HERZER, Marzling (DE)

(21) Appl. No.: 17/829,035

(22) Filed: May 31, 2022

(51) Int. Cl. H02M 3/335; H02M 1/00

(52) U.S. Cl. CPC H02M 3/33592; H02M 1/0058

(57) ABSTRACT

A voltage converter includes a switch network, a rectifier, and a transformer coupled between the switch network and the rectifier. The voltage converter includes an adaptive ON-time generation circuit having a control input and a control output, the control input. The adaptive ON-time generation circuit is configured to receive a WAKE signal to turn ON the switch network, generate a signal indicative of an OFF time of the switch network, and determine an ON time for the switch network based on the signal indicative of the OFF time.

### BACKGROUND

A voltage converter converts an input voltage (e.g., a direct current (DC) voltage) to a regulated DC output voltage. One type of voltage converter is an isolated voltage converter. An isolated voltage converter includes an isolation barrier between the input and the output. The isolation barrier may be implemented as a transformer. A transformer has a primary coil and a secondary coil. Because transformers transfer energy between the primary and secondary cons using time-varying currents, the primary side of an isolated voltage converter includes a switch network which is coupled to the DC input voltage, The switch network includes multiple transistors which are switched at relatively high rates to use the DC input voltage to generate a switching waveform to the terminals of the primary coil to thereby transfer energy from the primary coil to the secondary coil. A rectifier is coupled to the secondary coil to convert the time-varying voltage on the secondary coil back to a DC voltage.

### SUMMARY

A voltage converter includes a switch network, a rectifier, and a transformer coupled between the switch network and the rectifier. The voltage converter includes an adaptive ON-time generation circuit having a control input and a control output, the control input. The adaptive ON-time generation circuit is configured to receive a WAKE signal to turn ON the switch network, generate a signal indicative of an OFF time of the switch network, and determine an ON time for the switch network based on the signal indicative of the OFF time.

### BRIEF DESCRIPTION OF THE DRAWINGS

FIG. 1 is a schematic of an isolated voltage converter, in accordance with an example.

FIG. 2 is a waveform illustrating the output voltage of the converter for different load conditions, in accordance with an example.

FIG. 3 is a circuit schematic illustrating an adaptive ON-time generation circuit, in accordance with an example.

FIG. 4 are waveforms illustrating signals within the adaptive ON-time generation circuit of FIG. 3, in accordance with an example.

FIG. 5 is a block diagram illustrating another example of an adaptive-ON time generation circuit, in accordance with one or more embodiments.

### DETAILED DESCRIPTION

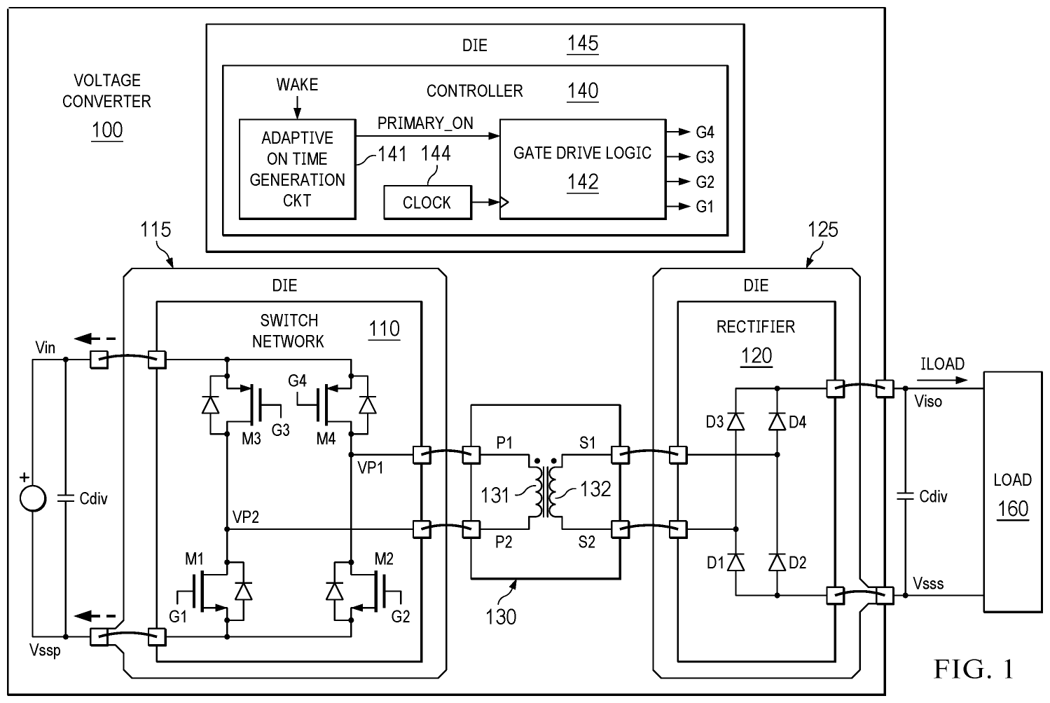

FIG. 1 is a schematic diagram illustrating an embodiment of an isolation voltage converter 100. The transformer converts an input voltage, Vin, to a regulated output voltage, Viso. In this example, the voltage converter 100 includes a transformer 130, a switch network 110, a rectifier 120, and a controller 140. In this example, the switch network 110, rectifier 120, and controller 140 are each implemented on individual dies 115, 125, and 145, respectively.

The transformer 130 includes a primary coil 131 and a secondary coil 132. The terminals of the primary coil 131 are labeled P1 and P2 as shown and are coupled to the switch network 110. The terminals of the secondary coil 132 are labeled S1 and S2 and are coupled to the rectifier 120.

In this example, the switch network 110 includes transistors M1, M2, M3, and M4. Transistors M1 and M2 are N-channel field effect transistors (NFETs), and transistors M3 and M4 are P-channel field effect transistors (PFETs). The sources of transistors M3 and M4 are coupled together and to the input voltage Vin. The drains of transistors M3 and M1 are coupled together, and the drains of transistors M4 and M2 are coupled together. The connection between the drains of transistors M3 and M1 is a switch node (also referred to as a “switch terminal”) labeled VP2. The connection between the drains of transistors M4 and M2 is a switch node (switch terminal) labeled VP1. The sources of transistors M1 and M2 are coupled together and to ground (VSSP). Switch nodes VP1 and VP2 are coupled to terminals P1 and P2, respectively, of the primary coil 131.

The gates of transistors Ml, M2, M3, and M4 are driven by signals labeled G1, G2, G3, and G4, respectively. The controller 140 includes gate drive logic 142 that generates the signals G1-G4 for the transistors of the switch network 110. The controller 140 turns the switch network 110 ON and OFF to regulate the output voltage, Viso. When the voltage converter is ON, the controller 140 uses a clock 144 to toggle signals G1-G4 high and low in such a manner to cause a switching voltage waveform to be generated between the switch nodes VP1 and VP2, and thus across the terminals P1 and P2 of the transformer's primary coil 131. In one example, during each switching cycle the controller causes G1 and G4 to be at an appropriate voltage level to turn ON corresponding transistors M1 and M4 (while G2 and G3 are forced to a level to cause M2 and M3 to be OFF). During this state, current flows from Vin, through transistor M4, through the primary coil from P1 to P2, and through transistor M1 to Vssp. Then, during the same switching cycle the controller causes G2 and G3 to be at an appropriate voltage level to turn ON transistors M2 and M3 (while G1 and G4 are forced to a level to cause M1 and M4 to be OFF). During this state, current flows from Vin, through transistor M3, through the primary coil from P2 to P1, and through transistor M2 to Vssp. This process repeats over and over (multiple switching cycles) during the “ON” phase of the converter's operation. The frequency of clock 144 may be any suitable frequency. In one example, the frequency of clock 144 is 20 MHz to 30 MHz, but it can be higher or lower than this range.

In this example, the rectifier 120 is a full bridge rectifier including four diodes D1, D2, D3, and D4. The anode of diode D3 is coupled to the cathode diode D1 and to terminal S2 of the secondary coil 132 of the transformer. The anode of diode D4 is coupled to the cathode diode D2 and to terminal S1 of the secondary coil 132. The cathodes of diodes D3 and D4 are coupled together to provide the output voltage, Viso, which is referenced with respect to the voltage on the anodes of diodes D1 and D2 which are coupled together (Vsss).

During the ON phase in which the transistors of the switch network 110 are switched as described above, current flows into an output capacitor Cdiv coupled between Viso and Vsss. The voltage on capacitor Cdiv is Viso, and Viso increases approximately linearly during the ON phase as capacitor Cdiv is charged by the current produced by the rectifier 120.

During the OFF phase, the controller 140 tri-states (turns OFF) all of the transistors M1-M4 of the switch network 110. During the OFF phase, no energy is transferred from the primary coil 131 to the secondary coil 132, and the charge previously stored in capacitor Cdiv is used to provide a load current ILOAD to a load 160 coupled to Viso. Accordingly, during the ON phase, Viso increases, and during the OFF phase, Viso decreases. The difference between the peak level of Viso and the valley level of Viso is the output ripple voltage. Voltage converters are designed for a predetermined upper threshold of ripple voltage.

Some voltage converters regulate the magnitude of its DC output voltage (Viso) by providing a feedback signal from the output to the control circuitry of the input. The feedback signal indicates whether the output voltage is becoming too high or too low. For a conventional isolated voltage converter, a circuit on the output of the converter detects when Viso has exceeded an upper threshold, and when the Viso has fallen below a lower threshold. The upper and lower thresholds define the ripple voltage. When the upper threshold is exceeded by Viso, an OFF signal is communicated from the secondary side through the transformer 130 back to the controller of the primary side to cause the controller to tristate the transistors of the switch network to thereby cause Viso to decrease. When Viso falls below the lower threshold, a WAKE signal may be communicated from the secondary side through the transformer 130 back to the controller of the primary side to cause the controller to toggle the ON and OFF states of the transistors of the switch network as described above to thereby cause Viso to increase.

Communicating an OFF signal through transformer 130 is problematic. During the ON phase of the converter's operation, a time-varying current is flowing through the primary and secondary coils of the transformer 130 thereby making it difficult to use the transformer also to provide a data channel from the secondary side back to the primary side for communication of the OFF signal. Additional circuitry on a separate die may be included in such systems to provide the data channel. During the OFF phase, the transformer is not being used and communicating a WAKE signal back through the transformer is relatively easy and does not require much additional circuitry.

In accordance with the described embodiments, a WAKE is communicated from the secondary side of the transformer 130 to the controller 140 to cause the converter to turn on, but an OFF signal is not communicated across the transformer to turn it off. Instead, the controller 140 includes an adaptive ON-time generation circuit 141 to adaptively determine the length of time for the ON phase of the converter's operation. The length of the ON time is adaptive based on the load condition.

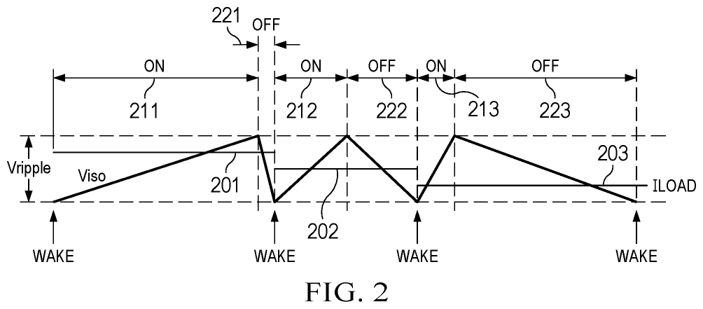

FIG. 2 shows the ramp up and down progression of Viso for three different load conditions. Each load condition is characterized by a different magnitude of load current ILOAD. ILOAD current at 201 is higher than ILOAD current at 202, which itself is higher than ILOAD current at 203. Each ON time period 211, 212, and 213 is initiated by the controller 140 in response to a WAKE signal transmitted through the transformer 130 from the secondary side to the primary side. The controller 140 responds to each assertion of the WAKE signal by operating the switch network 110 as described above to create the switching waveform on the switch nodes VP1 and VP2. The length of the ON time is related to the load condition. A higher load condition (201) requires the ON time to be longer than a lighter load condition (202 or 203). Accordingly, with the decreasing load condition shown in FIG. 2, the length of the respective ON time also decreases.

Further, lighter load conditions are characterized by a shorter duration of the OFF phase. At the lightest load condition shown in FIG. 2 (203), the length of the OFF time 223 is longer than the two higher load conditions. The length of the OFF time (221) for the highest load condition shown (201) is the shortest amongst the three load conditions shown in FIG. 2.

In accordance with the embodiments described herein, the adaptive ON-time generation circuit 141 determines the length of each ON-time of the converter's ON phase based on the length of time of each OFF phase-shorter OFF phases (higher load conditions) result in longer ON times, and longer OFF phases (lighter load conditions) result in shorter ON times.

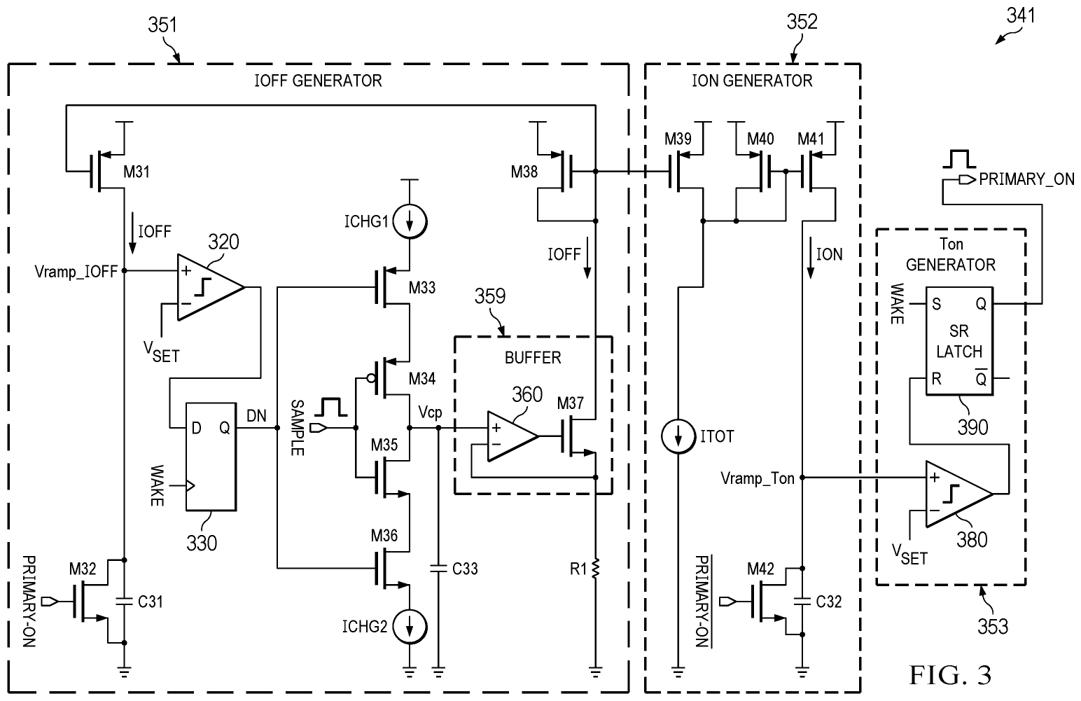

FIG. 3 is a schematic of an adaptive ON-time generation circuit 341 usable as the adaptive ON-time generation circuit 141 of FIG. 1. In the example of FIG. 3, the adaptive ON-time generation circuit 341 includes an IOFF generator 351, an ION generator 352, and a TON generator 353. The IOFF generator 351 generates a current IOFF through transistor M1 that is a function of the length of the OFF time of the converter. During each OFF phase, the magnitude of IOFF is adjusted based on the length of time of the respective OFF phase. Accordingly, the magnitude of IOFF is a proxy for the length of time of the OFF phase. As described below, the ION generator 352 generates an ION current based on the magnitude of the IOFF current. The magnitude of the ION current is a proxy for the length of time of the ON phase of the converter's operation. The TON generator 353 uses the ION current to generate a digital pulse, TON, which asserted high during the ON phase of the converter's operation.

The IOFF generator 351 includes transistors M31, M32, M33, M34, M35, M36, M37, and M38 capacitors C31 and C33, a comparator 320, a data (D) flip-flop 330, current sources ICH1 and ICH2 (whose currents are equal to each other), and an operational amplifier (OP AMP) 360. Transistors M31, M33, M34, and M38 are PFETs, and transistors M32, M35, M36, and M37 are NFETs. The drain of transistor M31 is coupled to one terminal of capacitor C31 and to the drain of transistor M32. The source of transistor M32 is coupled to ground, as is the opposing terminal of capacitor C31. Transistor M32 functions as a switch to permit (when transistor M32 is OFF/open) the IOFF current to charge capacitor C31, and to discharge capacitor C31 when transistor M32 is ON/closed).

The voltage on capacitor C31 is Vramp_IOFF and is coupled to the non-inverting (+) input of comparator 330. A reference voltage (VSET) is coupled to the comparator's inverting (−) input. The output of comparator 320 is coupled to the D input of the D flip-flop 330. The clock input of the D flip-flop receives the WAKE signal, which is asserted high (rising edge) when the converter should perform an ON phase to cause Viso to increase. The Q output of the D flip-flop is a signal labeled ‘DN’.

Transistors M33-M36 are coupled in series between current sources ICHG1 and ICHG2. The DN signal is provided to the gates of PFET M33 and NFET M36. The gate of PFET M34 and the gate of NFET M35 receive a sample signal (SAMPLE). The drains of transistors M34 and M35 are coupled together and to capacitor C33. Capacitor C33 is charged (when M33 and M34 are ON), discharged (when M35 and M36 are ON), or the voltage on capacitor C33 (Vcp) remains fixed when no current path is open through the transistor chain of M33-M36.

The non-inverting input of OP AMP 360 receives the Vcp voltage. The output of OP AMP 360 is coupled to the gate of transistor M37. The combination of OP AMP 360 and transistor M37 forms a buffer 359. The source of transistor M37 is coupled to the inverting input of the OP AMP and to one terminal of resistor R1. The OP AMP's inverting and non-inverting inputs have approximately the same voltage at steady state, and thus the voltage applied to resistor R1 is approximately equal to Vcp. The IOFF current is generated based on the voltage Vcp being applied to resistor R1. Accordingly, IOFF is equal to Vcp/R1. Transistor M38 is coupled to transistor M31 to form a current mirror (e.g., having a current mirror ratio of 1:1). Accordingly, IOFF through transistor M38 is mirrored through transistor M31.

The ION generator 352 includes transistors M40, M41, and M42, and a capacitor C32. In one embodiment, the capacitance of capacitor C32 is approximately equal to the capacitance of capacitor C31. Transistors M39 and M41 are PFETs and transistor M42 is an NFET. Transistor M42 is operated as a switch. When open, ION current from transistor M41 flows to and charges capacitor C32. The voltage on the upper plate of capacitor C32 is Vramp_TON. When transistor M42 is on/closed, Vramp_TON is approximately 0 V. Transistor M39 is coupled to transistor M38 to form a current mirror (having a current mirror ratio of, for example, 1:1). Transistors M40 and M41 are also coupled to form a current mirror. A current source ITOT is coupled between the drains of transistors M39 and ground. The current through transistor M39 is IOFF, and the current through transistor M41 is ION. The sum of currents IOFF and ION equals ITOT.

The TON generator 353 includes a comparator 380 and a set-reset (SR) latch 390. The set (S) input to the SR latch 390 receives the WAKE signal, and the reset (R) input to the SR latch is coupled to the output of comparator 380. The Q output of the SR latch 390 is the PRIMARY_ON signal. When logic high, PRIMARY_ON causes transistor M42 to be OFF and ION current to thereby charge capacitor C32, while transistor M32 is ON and Vramp_IOFF is held low (e.g., 0 V). Capacitor C32 being charges cause Vramp_TON to ramp up. When logic low, PRIMARY_ON causes transistor M32 to be OFF and IOFF current to thereby charge capacitor C31, while transistor M42 is ON and Vramp_TOFF is held low (e.g., 0 V). Capacitor C31 being charges cause Vramp_IOFF to ramp up.

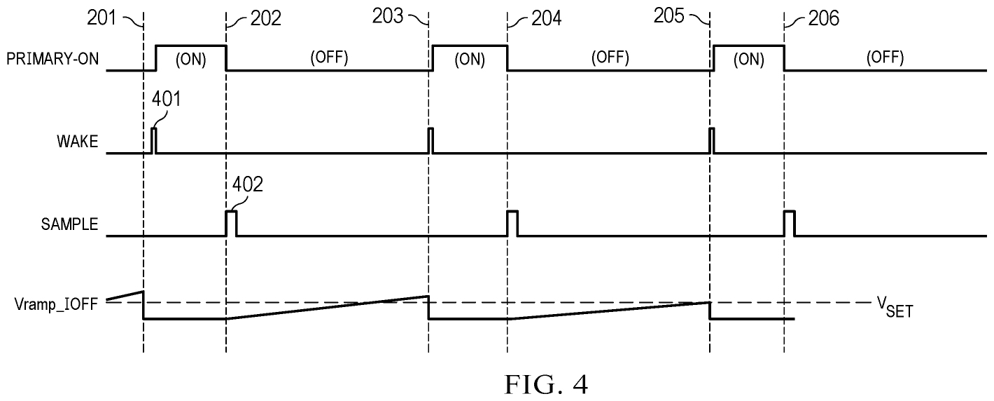

In describing the operation of the IOFF generator 351, reference will also be made to the waveforms of FIG. 4. The waveforms in FIG. 4 include PRIMARY_ON, WAKE, SAMPLE, and Vramp_IOFF. WAKE pulses high (such as that identified by reference numeral 401) for a short period of time to initiate each ON phase of the converter's operation during which the controller 140 toggles the ON and OFF power states of the transistors of the switch network 110 to cause a time-varying current to flow through the primary coil 131 of the transformer. The SR latch 390 responds to a high assertion of WAKE by asserting its Q output high (PRIMARY_ON). PRIMARY_ON will remain logic high during the ON phase of the converter's operation.

During the OFF phase immediately preceding the occurrence of the WAKE pulse, PRIMARY_ON was logic low thereby turning off transistor M32 and causing the IOFF current to charge capacitor C31. The comparator 320 compares Vramp_IOFF to Vset. When the WAKE pulse occurs, the D flip-flop 330 latches in the state of the comparator's output as signal DN. DN will be a logic low (0) if IOFF was not high enough to charge capacitor C31 to a voltage (Vramp_IOFF) at least equal to Vset. Otherwise, DN will be a logic high (1) if IOFF was high enough to charge capacitor C31 to a voltage (Vramp_IOFF) at least equal Vset.

FIG. 4 shows that SAMPLE is low when WAKE pulses high. With SAMPLE being logic low, transistor M34 is ON and transistor M35 is OFF. If DN is a 0, then transistor M33 is turned ON and transistor M36 is turned ON. At this point, both transistors M33 and M34 are ON, and ICHG1 current flows through transistors M33 and M34 to add charge to capacitor C33 thereby increasing the Vcp voltage. Capacitor C33 begins charging as soon as the Q output of the D flip-flop changes state to a logic 0, and the charging ends when SAMPLE becomes logic high (402), which causes transistor M34 to be OFF thereby interrupting the flow of charge current to capacitor C33. The amount of charge added to capacitor C33 is a function of the magnitude of ICHG1 and the time between DN becoming logic low and SAMPLE becoming logic high. Voltage Vcp is also forced on the resistor R1. With Vcp increased, current IOFF increases through transistor M37, and the increased IOFF current is also mirrored through transistors M31 and M39. Because the sum of IOFF and ION equals ITOT, then an increase in IOFF causes a commensurate reduction in ION. Current ION is a proxy for the ON time of the ON phase of the converter's operation.

DN being a 1 indicates that the IOFF current is high enough for VRAMP_IOFF to have exceeded Vset during the preceding OFF phase. In this case, transistor M33 is turned OFF and transistor M36 is turned ON. With SAMPLE being a logic 0, transistor M34 is ON, and transistor M35 is OFF. At this point, there is no active current path to either charge or discharge capacitor C33. However, when SAMPLE subsequently pulses high (402), transistor M35 turns ON thereby providing a discharge current path from capacitor C33 through transistors M35 and M36, which reduces the magnitude of Vcp. Capacitor C35 thereby partially discharges during the time during which SAMPLE is logic high and as limited by the magnitude of ICHG2. The decrease in Vcp also causes a decrease in current IOFF through transistor M37, and the decreased IOFF current is also mirrored through transistors M31 and M39. Because the sum of IOFF and ION equals ITOT, then a decrease in IOFF causes a commensurate increase in ION.

As described above, the IOFF generator 351 adjusts the magnitude of IOFF so that the capacitor C31 charges to a voltage approximately equal to Vset during each OFF phase of the converter's operation. In this manner, IOFF is a proxy for the length of time of the OFF phase. IOFF is then used to adjust ION, which is therefore a proxy for the ON time.

During an ON phase, PRIMARY_ON is logic high. The gate of transistor M42 is controlled by the logical inverse of PRIMARY_ON and thus transistor M42 is OFF during the ON phase. The ION current charges capacitor C42 during the ON phase. Comparator C42 compares Vramp_TON to Vset. When Vramp_TON reaches Vset, the compactor forces its output to be logic high, which then resets the SR latch, and forces PRIAMRY_ON to become logic low indicating an end of the ON phase. The above-described repeats. The adjustment to IOFF and ION may take several cycles to reach a steady state.

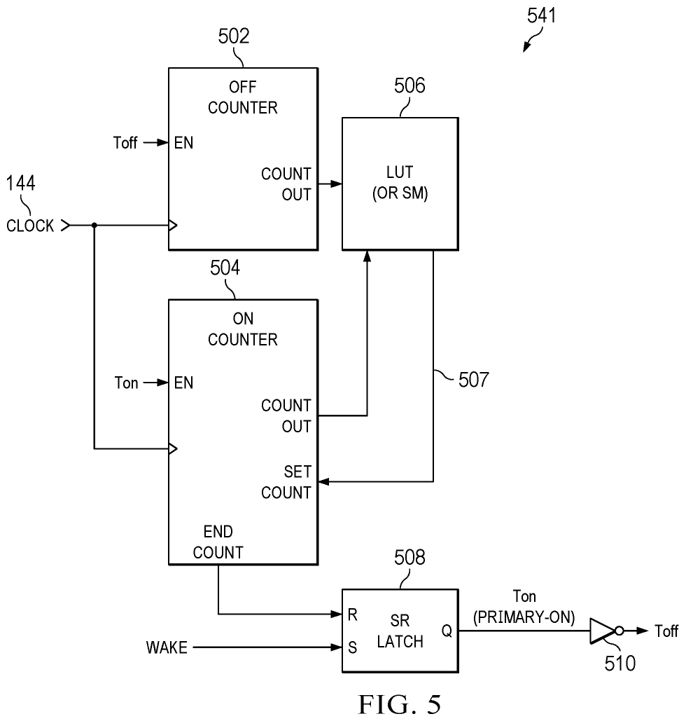

FIG. 5 shows another example of an adaptive ON-time generation circuit 541, which can be used as adaptive ON-time generation circuit 141 in FIG. 1. The adaptive ON-time generation circuit in this example includes an OFF counter 502, an ON counter 504, a look-up table 506, an SR latch 508, and an inverter 510. Each counter 502, 504 has an enable (EN) input and a clock input. Clock signal (CLOCK) 144 is provided to the clock inputs of each counter. When EN is asserted logic high, the respective counter counts pulses of CLOCK 144, and when EN is logic low, the counter does not count CLOCK pulses. The COUNT OUT of each counter is a signal indicative of the number of cycles of CLOCK counted while the respective counter is enabled, and thus is an indication of the amount of time that has elapsed while the EN input is logic high. The OFF counter 502 is used to count the length of the OFF phase of the converter's operation, and the ON counter 504 is used to count the length of the ON phase.

The ON counter 504 has an END COUNT output, which is pulsed logic high when counter 504 reaches a SET COUNT value programmed into the ON counter 504 by the LUT 506. The SET COUNT value is or is representative of the number of cycles of CLOCK that the ON COUNTER 504 should count when it is enabled. The END COUNT output from the ON counter 504 is coupled to the R input of the SR latch 508. The END COUNT is asserted high when the ON counter 504 is enabled and reaches the SET COUNT value. The S input of the SR latch 508 receives the WAKE signal, which, as described above, is transmitted across the transformer 130 from the secondary side to the primary side. A logic high assertion of WAKE causes the SR latch 508 to force its Q output high. The output signal from the SR latch 508 is Ton (also referred to as PRIMARY_ON in FIG. 3). The inverter 510 has input coupled to the Q output of the SR latch, and produces an output signal, Toff on its output. Toff is the logical inverse of Ton. Toff is the enable signal for the OFF counter 502, and Ton is the enable signal for the ON counter 504.

In response to a high assertion of WAKE, Ton is forced high by the SR latch 508 to begin the ON phase of the converter's operation. A high assertion of Ton enables the ON counter 504 to count pulses of CLOCK 144. In response to the count value of the ON counter reaching the SET COUNT value, END COUNT is asserted high thereby resetting the SR latch 508 and forcing Ton low. At that point, Toff becomes logic high, which enables the OFF counter 502. The OFF counter 502 counts cycles of CLOCK 144 during the OFF time, which progresses until the next high assertion of WAKE. Upon WAKE again asserting high, Ton again becomes logic high, and Toff is forced low thereby disabling the OFF counter 502.

The COUNT OUT value from the OFF counter 502 is provided to the LUT 506. The LUT 506 provides an output value 507 which corresponds to the OFF time COUNT OUT value. Both the ON time and the OFF time are functions of the ripple voltage (Vripple) on the output of the converter (Viso). For example, the OFF time is (Vripple×Cdiv)/Iload, where Iload is the load current. The ON time is (Vripple×Cdiv)/(charge current to Cdiv). A target maximum amount of ripple voltage thus dictates the maximum OFF time for a given ON time. The LUT 502 receives an indication of the OFF and ON times in the form of the COUNT OUT values from the respective OFF and ON counters 502 and 504. The LUT 506 may include registers and other digital circuit components to determine if the current combination of ON and OFF times correspond to a ripple voltage that is equal or less than the target maximum ripple voltage. If the current combination of ON and OFF times corresponds to a ripple voltage that is equal or less than the target maximum ripple voltage, then the LUT 506 does not change the SET COUNT for the ON counter 504 or configures it for the same SET COUNT. However, if the current combination of ON and OFF times corresponds to a ripple voltage that is greater than the target maximum ripple voltage, then the LUT 506 provides an updated SET COUNT value to the ON counter 504 that is smaller than the previous value of SET COUNT.

In one embodiment, two, three, four, or more possible values of the ON time can be provided by the LUT 506. Rather than an actual ON time in units of seconds, the LUT 506 may provide a count value that represents the number of cycles of CLOCK 144 corresponding to the target ON time (Non). In one example, Non may be set to a value selected from 8, 16, 32, or 64. In some embodiments, for higher efficiency, the largest value of Non is selected by the LUT 506 that results in an acceptable level of ripple voltage. When a converter turns ON, a number of switching cycles are expended during which the converter reaches steady state, and thus a larger number of switching cycles during the ON time results in higher efficiency than a lower number of switching cycles. However, a smaller amount of ON time may be needed at higher OFF times, as described above.

In another embodiment, a state machine may be used in place of the LUT 506. The state machine may be a combination of logic gates, flip-flops, etc. that implement the functionality described above. In the embodiment in which a state machine is used, the COUNT OUT from the ON counter 504 is not necessarily provided as an input to the state machine because the state machine would already track the state of the SET COUNT value for the ON COUNTER. Any suitable type of logic circuit (e.g., LUT, state machine, etc.) can be included to implement the functionality described above.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead. For example, a p-channel field effect transistor (“PFET”) may be used in place of an n-channel field effect transistor (NFET) with little or no changes to the circuit. Furthermore, other types of transistors may be used (such as bipolar junction transistors (BJTs)).

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately,” or “substantially” preceding a parameter means +/−10 percent of the stated parameter.

Modifications are possible in the described embodiments, and other embodiments are possible, within the scope of the claims.

What is claimed is:

1. A voltage converter, comprising:
a switch network;
a rectifier;
a transformer coupled between the switch network and the rectifier; and
an adaptive ON-time generation circuit having a control input and a control output, the control input is configured to:
receive a WAKE signal to turn ON the switch network;
generate a signal indicative of an OFF time of the switch network; and
determine an ON time for the switch network based on the signal indicative of the OFF time.

2. The voltage converter of claim 1, wherein the adaptive ON-time generation circuit comprises:
an OFF current generator configured to generate an OFF current of a first magnitude that charges a capacitor to approximately a threshold voltage during the OFF time of the switch network; and
an ON current generator configured to produce an ON current of second magnitude based on the first magnitude.

3. The voltage converter of claim 2, wherein the OFF current generator includes:
a first capacitor;
a first current source circuit configured to provide a charge current to the first capacitor during the OFF time of the switch network to increase a first capacitor voltage of the first capacitor;
a comparator having a first input coupled to the first capacitor and having a reference voltage input, the comparator having a comparator output;
a second capacitor;
a first current path configured to provide a charge current to the second capacitor in response to the comparator output indicating that first capacitor voltage has exceeded a voltage on the reference voltage input;
a second current path configured to provide a discharge current from the second capacitor in response to the comparator output indicating that first capacitor voltage is below the voltage on the reference voltage input;
a buffer having a buffer input and a buffer, the buffer input coupled to the second capacitor; and
a resistor coupled to the buffer output.

4. The voltage converter of claim 3, wherein the ON current generator includes:
a second current source circuit;
a first transistor configured to provide the OFF current;
a second transistor configured to provide the ON current, wherein a sum of the OFF current and the ON current is approximately equal to a current through the current source circuit; and
a third capacitor coupled to the second transistor.

5. The voltage converter of claim 4, further including an ON time generator having a first input coupled to the third capacitor and having an ON time generator output, the ON time generator configured to generate an output pulse on the ON time generator output having a pulse width equal to the ON time.

6. The voltage converter of claim 5, wherein the ON time generator comprises:
a comparator having a first comparator input that is the first input and having a second voltage reference input, the comparator having a comparator output; and
a latch having a set input and a reset input, the reset input coupled to the comparator output, and the set input configured to receive a control signal indicative of when to turn on the switch network.

7. The voltage converter of claim 1, wherein the adaptive ON-time generation circuit comprises:
an OFF counter having first enable input, a first clock input, and a first count output;
an ON counter having a second enable input, a second clock input, a second count output, a set count input, and an end count output;
a look-up table (LUT) having a first LUT input, a second LUT input, and an output, the first count output coupled to the first LUT input, the second count output coupled to the second LUT input, and the output of the LUT coupled to the set count input; and
a latch having a reset input coupled to the end count output.

8. The voltage converter of claim 7, wherein the latch has a set input configured to receive the WAKE signal.

9. The voltage converter of claim 7, wherein the latch has a latch output, and the voltage converter further comprises an inverter having an inverter input and an inverter output, the latch output coupled to the inverter input and to the second enable input, and the inverter output coupled to the first enable input.

10. The voltage converter of claim 1, wherein the adaptive ON-time generation circuit comprises:
an OFF counter having first enable input, a first clock input, and a count output;
an ON counter having a second enable input, a second clock input, a set count input, and an end count output;
a state machine having a state machine input, and a state machine output, the count output coupled to the state machine input, and the state machine output coupled to the set count input; and
a latch having a reset input coupled to the end count output, the latch also having a set input configured to receive the WAKE signal.

11. A voltage converter, comprising:
a switch network;
a rectifier;
a transformer coupled between the switch network and the rectifier;
an OFF current generator including a first capacitor, the OFF current generator configured to generate an OFF current of a first magnitude that charges the capacitor to approximately a threshold voltage during an OFF time of the switch network; and
an ON current generator configured to produce an ON current of second magnitude based on the first magnitude of the OFF current.

12. The voltage converter of claim 11, further including:
a first current source circuit configured to provide a charge current to the first capacitor during the OFF time of the switch network to increase a first capacitor voltage of the first capacitor;
a first comparator having a first input coupled to the first capacitor and having a reference voltage input, the comparator having a comparator output;
a second capacitor;
a first current path configured to provide a charge current to the second capacitor in response to the comparator output indicating that first capacitor voltage has exceeded a voltage on the reference voltage input;
a second current path configured to provide a discharge current from the second capacitor in response to the comparator output indicating that first capacitor voltage is below the voltage on the reference voltage input;
a buffer having a buffer input and a buffer, the buffer input coupled to the second capacitor; and
a resistor coupled to the buffer output.

13. The voltage converter of claim 12, further comprising:
a second current source circuit;
a first transistor configured to provide the OFF current;
a second transistor configured to provide the ON current, wherein a sum of the OFF current and the ON current is approximately equal to a current through the current source circuit; and
a third capacitor coupled to the second transistor.

14. The voltage converter of claim 13, further including an ON time generator having a first input coupled to the third capacitor and having an ON time generator output, the ON time generator configured to generate an output pulse on the ON time generator output having a pulse width equal to the ON time.

15. The voltage converter of claim 14, wherein the ON time generator comprises:
a second comparator having a second comparator output; and
a latch having a set input and a reset input, the reset input coupled to the second comparator output, and the set input configured to receive a control signal indicative of when to turn on the switch network.

16. A voltage converter, comprising:
a switch network;
a rectifier;
a transformer coupled between the switch network and the rectifier;
an OFF counter having first enable input, a first clock input, and a first count output;
an ON counter having a second enable input, a second clock input, a set count input, and an end count output;
a logic circuit having a first logic circuit input and having a first logic circuit output, the first count output coupled to the first logic input, and the output of the logic circuit coupled to the set count input; and
a latch having a reset input coupled to the end count output.

17. The voltage converter of claim 16, wherein the logic circuit is at least one of a look-up table or a state machine.

18. The voltage converter of claim 16, wherein the latch has a set input configured to receive a control signal whose assertion causes the voltage converter to be turned ON.

19. The voltage converter of claim 16, wherein the latch has a latch output, and the voltage converter further comprises an inverter having an inverter input and an inverter output, the latch output coupled to the inverter input and to the second enable input, and the inverter output coupled to the first enable input.

20. The voltage converter of claim 16, wherein:
the logic circuit is a look-up table (LUT), the LUT has the first logic circuit input, and the LUT has a second logic circuit input; and
the ON counter has a second count output coupled to the second logic circuit input.
